(19) United States
(12) Patent Application Publication
(10) Pub. No.: US 2016/0027106 A1
(43) Pub. Date: Jan. 28, 2016

(54) COMPUTER-BASED PEER-TO-PEER ROTATING SAVINGS AND LENDING ALLOWING FOR A REVOLVER-TYPE CREDIT SYSTEM AND METHOD

(71) Applicant: Rosca Finance LLC, Princeton, NJ (US)

(72) Inventors: Aamer Shahab, Princeton, NJ (US); Brian Chin, Montebello, NY (US)

(73) Assignee: ROSCA FINANCE LLC, Princeton, NJ (US)

(21) Appl. No.: 14/807,682

(22) Filed: Jul. 23, 2015

Related U.S. Application Data
(60) Provisional application No. 62/028,753, filed on Jul. 24, 2014.

(51) Int. Cl. G06Q 40/02

(52) U.S. Cl. CPC G06Q 40/025

(57) ABSTRACT

The present invention concerns generally with a computer-based peer-to-peer lending platform, and, more particularly, with an improved internet-based peer-to-peer rotating lending and savings allowing a revolver type credit platform implemented through a method, computer system, and computer-implemented algorithm directed at compensating peer-to-peer lending circles' participants for the time value of money and time-driven default risks, and allowing borrowing against a credit rating-based credit limit.

This application claims the benefit of U.S. Provisional Application No. 62/028,753 filed Jul. 24, 2014.

### FIELD OF THE INVENTION

The present invention concerns generally with a computer-based peer-to-peer lending and savings platform, and, more particularly, with an improved computer-based peer-to-peer rotating savings and lending allowing for a revolver type credit platform implemented through a method, computer system, and computer-implemented algorithm directed at compensating peer-to-peer lending circles' participants for the time value of money and credit-driven risks of default, and allowing borrowing against a credit rating-based credit limit.

### BACKGROUND OF THE INVENTION

A system for savings and extending credit called a Rotating Savings and Credit Association (“ROSCA”) has been used for centuries. It works when a group of individuals who agree to meet at intervals over a defined period of time for the purpose of saving and borrowing among each other. The meetings can be held regularly or tied to seasonal cash flow cycles that suit the members. At the meetings, each member makes equal contributions of money to a pool that is, in turn, distributed to one member of the group. With the exception of the last recipient, each member, thus, has access to a sum of money earlier than he or she would otherwise have had if left to their own devices over a time period equal to the cycle of the ROSCA. Usually, the member who is entitled to the current period's money is picked by lottery or in some other manner agreed by the members. The number of times the group meets must coincide with the number of members, since each member will receive one funds distribution per iteration throughout the lifecycle of the ROSCA. Once all the members of the ROSCA cycle have received their funds, the group disbands.

The traditional ROSCA model can be viewed as social finance. The individuals participating in a given ROSCA cycle are not compensated for the time value of money because all participants, whether they receive their distributions first or last, receive the same amount of money. In addition, since the participants who have already collected their distributions may be unable or unwilling to pay their share in the future, the risk of default increases as time progresses over the cycle of the ROSCA. Consequently, defaults thus adversely affect those participants who are collecting funds later in the cycle.

Thus, a clear incentive exists for each participant of the ROSCA cycle to want to be in the first position to collect the money. Second position is the next best alternative, and so on. Often times, the traditional ROSCA cycle resorts to lottery or otherwise democratic means in order to determine the order of distributions.

In recent years, multiple solutions have been developed directed at improving traditional ROSCA models. With the proliferation of the Internet and the wide availability of online ROSCAs, a large number of people can now easily participate in the process without a need of meeting in person, as the traditional ROSCAs require. Development of web-based peer-to-peer (“P2P”) platforms allows individuals and business entities, which are considered to be peers to each other, to interact directly over the Internet. Participants that lend and invest in P2P ROSCA platforms bypass traditional financial intermediaries such as banks and deal directly with each other.

### SUMMARY OF THE INVENTION

As the foregoing explains, current P2P lending offerings typically operate in a way similar to that of loan securitizations. For example, typical loan securitizations pool financial assets and repackage them into pieces that are separated into default-based risk tiers. The pieces are then marketed to investors. Current online P2P providers re-sell pieces of whole loans that are repackaged and sold to investors. In addition, the P2P process is conducted entirely online.

Current rotating and savings credit associations (ROSCA's) are typically social groups that gather and decide to pool their financial resources so that members can utilize the funds one member at a time. In these associations, members make equal monthly payments to a collective pool with participants rotating each month so that one member will receive the pool of funds that month. A typical rotating and savings credit association has 12 participants where a different participant will receive the pool of funds each month over a twelve-month period.

The present invention, directed at an “online P2P ROSCA”, combines the concepts of online P2P lending and investing with those of rotating savings and credit associations. It enables participants to borrow and lend money online, but doing so on the basis of rotating savings and credit.

In effect, the present invention views participants as a hybrid of borrowers and lenders. All participants will make payments and will receive a funds distribution over a 12-months period (or another period selected by the participants or the implementer of the system). Because the proposed system is Internet based, the entire process is conducted online and anonymously. Participants do not need to know with whom they are transacting, though the system may identify certain credit risk parameters of the participants (for example, FICO scores for individuals or Intelliscore for companies) to help the other participants access the credit risk profile of the peers.

The present invention, while utilizing some elements of the traditional ROSCA model described above, is directed at a computer-based improved peer-to-peer online lending and credit platform. It is based on allowing rotating savings and credit among peers, and incorporates the time value of money component while compensating for a higher default risk with a higher return. In addition, the present invention offers a revolving credit limit feature.

As we stated previously, online peer-to-peer ROSCA-based lending mechanisms are well known in the business. They are attractive alternatives to traditional lending platforms due to their relative simplicity and low cost.

Despite their attractiveness, however, existing P2P online lending platforms are generally limited to providing unsecured loans of a fixed term of between three to five years. These lending platforms are mostly unavailable for non-bank entities; do not offer a revolving type feature, and peers and borrowers must borrow the total amount for which they have been approved.

In contrast, the present invention is capable of offering a short term funding alternative that is meaningfully less expensive than any other current market alternatives such as credit cards. Current fixed income short-term investment vehicles available to non-bank entities are limited to bank products such as CD's or deposit accounts. Short-term investments into other types of securities carry a higher risk of loss of principal. The present invention offers low-cost short-term investment opportunities, up to 12 months, to bank or non-bank entities alike.

Currently, cash management alternatives for small business are mostly limited to vendor financing, and, therefore, costly. A typical vendor financing will only offer inexpensive financing if payables are met in less than 90 days. The present invention offers a cash management alternative to small business that could effectively provide liquidity at affordably low rates.

The present invention divides registered participants into online groups called “lending circles” based mainly on the credit rating of each participant. Participants contribute and obtain cash from their peers in each circle. Participants are approved for a maximum credit limit that can be outstanding on their account and can obtain credit up to that limit at any point in time or projected to reach that limit in the future depending on the lending circle elections of the Participant.

The present invention allows participants, by using electronic computing devices and computer networks, to lend to others or borrow from the peers of the same circle and manage their cash flow while either maximizing the interest they receive or minimizing the interest to be paid.

### BRIEF DESCRIPTION OF DRAWINGS

These and other features of this invention will be more readily understood from the following detailed description of the various aspects of the invention taken in conjunction with the accompanying drawings in which:

FIG. 1 shows a high-level workflow diagram of the improved peer-to-peer lending platform;

FIG. 2 details element 120 of the foregoing workflow diagram further describing the scoring model directed at application approval, credit limit assignment, and risk rating;

FIG. 3 shows an exemplary embodiment of the dialog window used by an applicant to sign up for a new ROSCA user account using Facebook, LinkedIn, Twitter, email or a mobile telephone number;

FIG. 4 depicts an exemplary embodiment of the interface used by a returned user to log onto an existing ROSCA user account;

FIG. 5 shows an exemplary embodiment of the interface used by a registered user to apply online for a ROSCA borrowing limit;

FIG. 6 exemplifies the interface through which a qualified applicant receives approvals of the credit and investment limits respectively;

FIG. 7 shows an exemplary embodiment of the activity page;

FIG. 8 depicts an exemplary embodiment of the interface that provides real-time graphical viewing of actual and potential cash flows generated by a given circle participation.

### DETAILED DESCRIPTION OF THE INVENTION

The following is a detailed description of the invention provided to aid those skilled in the art in practicing in the field of the present invention. Those of ordinary skill in the art may make modifications and variations in the embodiments described herein without departing from the spirit or scope of the present invention. Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. All publications, patent applications, patents, figures and other references mentioned herein are expressly incorporated by reference in their entirety.

The present invention concerns generally with peer-to-peer lending, and, more particularly, with an improved internet-based peer-to-peer rotating lending and savings allowing for a revolver type credit platform implemented through a method, computer system, and computer-implemented algorithm directed at compensating peer-to-peer lending circles' participants for the time value of money and time-driven risks of default, and allowing borrowing against a credit rating-based credit limit.

All peer-to-peer participants are registered online through a graphic user interface (“GUI”, or “interface”), rated and assigned a risk level, which reflects their propensity to default, which is a situation when a participant collected the pooled funds but failed to make required contributions in subsequent periods.

In one exemplary embodiment, all registered participants are assigned risk ratings from “A” to “E”, where “A”-rated borrowers have the lowest risk of default and, thus, the highest rating and “E”-rated borrowers have the highest risk of default and, thus, the lowest rating.

Online lending circles of peers are established for each risk rating, in which participants rated “A” can select to join any circle with risk rating from “A” to “E”, participants rated “B” can select to join any circle rated from “B” to “E”, but not A, participants rated “C” can select to join any circle rated from “C” to “E”, but not “A” or “B”, and so on.

Unlike the traditional ROSCA, under the present invention, the periodic payments to be made by the participants in each circle will increase each time by a defined amount. In one exemplary embodiment, the first payment would be $100, the second $101, the third $102, and so on. The increasing stream of payments compensates for the time value of money, a function that is unavailable in the traditional ROSCA.

The amount of that periodic payment increment depends on the risk rating of a given lending circle. For example, an “A”-rated circle may have a first payment of $100, a second of $101, a third of $102, and so on. An “E”-rated circle may have a first payment of $100, second of $105, third of $110 and so on. Thus, higher payment increments compensate participants for the higher risk of default as they progress from the “A”-rated circle to the “E”-rated circle.

Participants select the month or period in each circle when they wish to receive distribution. There is no element of chance or lottery as in the traditional ROSCA, where participants are not compensated for the time value of money or default risk, and, therefore, the best outcome is to receive the entire sum in the first distribution and the worst outcome is to receive the money in the last distribution.

Thus, in the present invention, the participants are compensated for both the time value of money and default risk by increasing monthly increments and by having higher increments for greater risk circles.

Accordingly, a participant with a highly rated “A”-rating, being attracted by a better compensation for the higher risk and time value of money, may choose to join a circle with an “E” rating and elect to receive payments at the end of the circle.

To illustrate the traditional ROSCA, let us suppose that each participant is willing to contribute $100 monthly and wishes to receive a lump sum of $1,200. Here, there must be 12 participants and they must meet once a month for 12 months.

In a similar case in the present invention, there is no requirement that there be exactly 12 participants. For example, there may be only four participants with one choosing payments in month one, the second choosing payment in month five, the third choosing payment in month eight and the fourth choosing month 12 for payments. In this case, the participants will only make payments in the selected months of 1, 5, 8 and 12 with the defined increments of the month; no payments will be made by any of the participants in the months not selected, and no funds distributions will occur in months 2, 3, 4, 6, 7, 9, 10 and 11.

The present invention takes the improved ROSCA further to allow the participants to borrow and save against a credit limit. Amounts borrowed or saved change over time such that the participants' accounts act as a revolving line of credit.

Because of the real time nature of the present invention and a complete geographical independence of the participants in a given investment circle, CPU and memory-equipped electronic devices, such as desktop or laptop computers, handheld devices, and so on, as well a variety of computers network, such as LAN, WAN, the Internet, and/or the like, are the essential elements of the present invention.

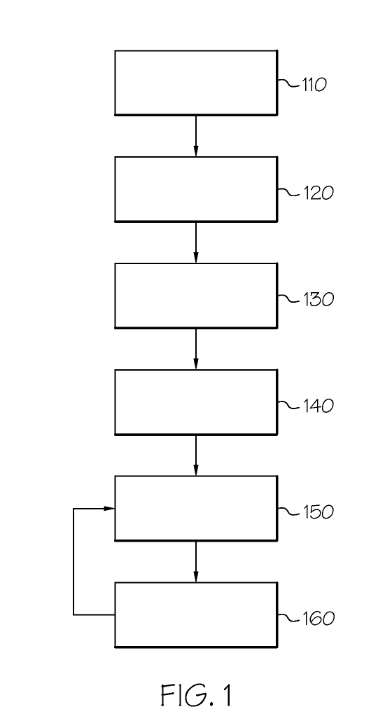

A block diagram of an exemplary embodiment of the improved peer-to-peer lending platforms shown in FIG. 1. Here, participants, upon registering online, fill out an online credit application, 110. Upon instantaneous approval via a proprietary credit-scoring model, participants are then assigned a real-time internal risk rating and given a maximum credit limit in accordance with their credit score, 120. Participants are then grouped into risk tiers in accordance with their assigned risk ratings. Each tier is, in turn, assigned to a relative stated interest rate on the basis of the likelihood of default of its members.

Once assigned to a given risk tier, participants use they electronic devices to select from a plurality of options, 130. At a bare minimum, a user may select in the group or circle to participate in (subject to limitation by an individual risk rating), choose a month of the distribution, and agree to a specific payment schedule.

In one exemplary embodiment, participants are given four choices: (1) a choice of a credit tier, which could be the assigned credit tier or a lower one, (2) a choice of different monthly payment levels; (3) a choice of the month of the year the participant would like to receive his or her distribution; and (4) a choice a circle, which is defined as a group of at least two joined participants.

A given online circle completes automatically 140 when either a) all the participants of the circle have entered; or b) at a predefined time as long as the minimum of two participants joined that circle. Thus, unlike the traditional ROSCA, there is no requirement for all 12 participants to be present in the circle; the present invention offers a savings and lending platform with at least two peers in a given circle.

Further referring to FIG. 1, by the end of the first month, all users accounts are debited for the amount they have agreed to contribute. The entire amount, less the processing fee, is distributed to the account of user electing to receive payment in month one, 150.

At the end of month 12, 160, when all users have paid their contracted amounts and received their elected distribution, the group/circle is deemed completed. At that point, users of the complete circle have an option of joining new groups and/or circles based on their credit limit availability. Process 160 repeats each month. If no user selects a particular month distribution, that month's distribution is not processed.

The following exemplary embodiment explains the proposed improved peer-to-peer lending platform in greater detail. Five independent and geographically diverse prospective clients—Adam, Bill, Charles, David, and Edward—want to participate in our P2P platform. Through their respective electronic devices, they visit the website and fill out their respective online credit application. Through a computer network their applications are transmitted to and processed by a computer that runs the application layer of the present invention. Instantaneously, Adam is approved for the $12,000 credit and assigned the “A” rating. Bill is approved for $6,000 and, because he has scored a lower credit rating, assigned the “B” rating. Similarly, Charles is approved for $4,000 and assigned the “C” rating. David is approved for $3,000 and assigned the “D” rating. Edward is approved for $1,200 and assigned an “E” rating.

Adam chooses to borrow, or invest, $6,000 of his $12,000 available credit, Bill chooses $4,800 of his available $6,000, Charles chooses $3,600 of his available $4,000, David chooses $2,400 of his available $3,000, and Edward chooses to use his entire $1,200.

Although participants may choose tiers that are of a higher risk rating, and, therefore yield a higher interest rate, for the sake of this example we assume that participants only participate in their assigned risk category. Accordingly, Adam chooses to participate in tier “A”, Bill chooses “B”, Charles chooses “C”, David chooses “D”, and Edward is left to participate in “E” tier.

As we previously explained, each participant is given a choice of a number of different monthly payment levels. In this example, we assume that the participants are offered three monthly payment choices of $25, $50, and $100. Adam and Bill choose to participate in $25 groups, Charles and David choose to participate in $50 groups, and Edward chooses to participate in $100 groups.

At $25 monthly payments, Adam must participate in 20 groups in “A” tier as 20×$300 per group yields $6000 in funds. Bill must participate in 16 groups in “B” as 16×$300 per group yields $4800. Charles must participate in 6 groups in “C” as 6 times $600 yields $3600. David must participate in 4 groups in “D” as 4×$600 yields $2400. Edward may participate in only one group in “E” as one ×$1200 yields $1200.

Assume the following interest rates for tiers “A”, “B”, “C”, “D”, and “E”: 8%, 13%, 16%, 20%, and 23%.

As we previously explained, each participant provides a certain amount of money on the first day the circle completes, increased by a certain increment every month until the 12-month anniversary of the circle closing date. For example, the monthly payment starts at $100 in month one, increasing to $101 on month two, and so on to $111 on month 12.

Each participant at the beginning of the circle elects the month when they want to receive funds. The increments' amounts vary, and there is no requirement that there are participants for every monthly position; the number of the participants may vary from a minimum of two to a maximum of 12 participants representing the 12 months of the circle.

Further referring to FIG. 1, we are assuming that there are 12 participants and each participant picks a month for distribution. Thus, in month one all participants contribute the full amount, and $1,200 will be given to the participant who selected the first month distribution, 150. Next month, all participants are obliged to contribute the next monthly amount with the increment, or $104.1 for example, and $1,250.16 will be given to the participant who selected month two for distribution. This will continue for each month in which participants have elected distributions. If no participant has elected to receive distribution in a given month, then no contribution or distribution will happen in that month, and the process moves to the following month, but the monthly increment will still be applied. Thus, the amount to be contributed in each month by all participants is fixed beforehand, but if no participant elects to take distribution in a given month, then no participant contributes in that particular month and the cycle moves to the next month.

At the conclusion of the 12-months period, all participants have made payments according to the agreement of the particular circle, and all participants have received distribution in the month that they originally elected, at which point the circle terminates, 160.

As we previously explained, upon completion of the online credit application, the participant is assigned both the credit score and the maximum credit limit. The participant is entitled to participate in as many circle she or she wishes as long as the aggregate net principal amount owed for all circles in which the participant is involved at any given time (or projected based on the participant's election in other circles) does not exceed the participant's assigned maximum credit limit.

Until cash flows occur, no net change occurs with regard to the available credit limit. Payments made prior to funds distribution increase available credit. Funds distributions reduce available credit by the amount distributed. Payments made after funds distribution increase available credit by the amount contributed.

As available credit rises and falls in accordance with cash flows, participants may reinvest available credit in new circles. That said, investments in new circles are constrained by the combination of remaining available credit and potential future obligations tied to funds distributions of newly invested circles. If obligations tied to future funds distributions exceed available credit at the time funds are distributed, participation in the related circle may be prohibited. The situation may potentially be rectified via changing the selected month for funds distribution.

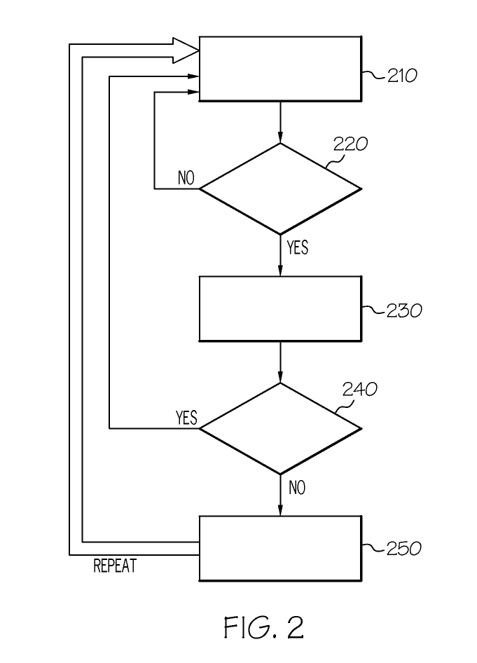

We now are turning to FIG. 2 showing a detailed workflow of the scoring model directed at application approval, credit limit assignment, and risk rating.

After completing the online credit application, the participant is assigned a risk rating, for instance, from the highest “A” to the lowest “E”, and given the maximum credit limit, for example, $3,000. At that time, the participant may choose a position in any circle the participant is qualified for, 210.

Once the participant chooses a position and circle, the application layer checks whether the participant's risk level allows him or her to participate in the selected circle, 220.

Further continuing with FIG. 2, and for exemplary purposes, let us assume that the participant chooses “B”-rated circle with payments of $100 in month one, $102 in month two, $104 in month three and so on to $122 in month 12, and the participant selects month 2 for funds distribution, and there are 12 participants in this circle.

The application checks the risk rating assigned to the participant, 220. Since the participant chooses “B” circle, its credit rating must be either “A” or “B” to qualify. If the participant's risk rating is lower than “B”, the system bars the participant from joining the circle and asks to select another circle, 210.

For the participant who satisfies the foregoing risk rating condition, the application layer projects the 12 months cash flow for the particular circle the user is wishing to join. The application layer adds that cash flow to the cash flows of any and all other circles the participant has already joined, 230. The application layer then accounts for the cumulative cash flows of all the circles in which the participant is involved and compares it to the participant's maximum credit limit; thus, ensuring the total obligations do not exceed the approved credit limit, 240.

If the approved credit limit is exceeded, the participant is not allowed to join that particular circle and is asked to either choose another circle or a different position in the selected circle and the validation process repeats anew, 210. If the approved credit limit is not exceeded, the participant is allowed to join that particular circle, 250.

The following example exemplifies the flow shown in FIG. 2. Let's assume the aforementioned approved participant selects to receive funds distribution in month two, which means that at the end of the second month the participant would have borrowed a net of $1,011: $100 paid in month one, $101 paid in month two, and $1,212 borrowed in the same month two. Since this amount is below the participant's approved credit limit of $3,000,the participant is allowed to join the circle.

At that point, the participant's available credit limit is $1,989, which is used to test the participant's ability to borrow in other circles that the participant wishes to join.

As the participant makes periodic agreed contributions to the circles the participant joined, the system recalculates the participant's future credit limit use as the participant attempts to join new circles. In this example, in month three, upon making a payment of $102, the system would changes the participant's available credit limit to $2,091.

As mentioned above, the present invention offers a computer-based peer-to-peer lending platform similar to that of the traditional ROSCA. However, while the traditional ROSCA incorporates fixed monthly payments, the business model of the present invention incorporates increasing monthly payments. In doing so, participants of the proposed computer-based lending platform are compensated for the time value of money and increased default risk. For example, a participant that receives his funds distribution in month 12 will be compensated at a higher rate comparing to a participant who receives his funds in month one.

In addition, existing P2P lending platforms provide term loans of a fixed amount of proceeds over a fix time frame from investors to borrowers. The present invention offers a computer-based lending mechanism that is not restricted by a fixed time frame or dollar amount. Contrary, participants in the proposed lending platform have a maximum credit limit approved. As they participate and borrow from circles in which they elected to join, if they have borrowed money, their credit limit would be reduced by that amount. As they make payments, the credit limit would be increased. This flexibility of borrowing, making payments and thus getting the participant's credit limit available for further borrowing is the revolving structure of the proposed platform.

The traditional ROSCA is defined by the prerequisite that funds be collected and distributed every month. The proposed computer-based lending platform allows flexible collections or distributions. In the event that a given circle does not contain a full cadre of 12 people, funds will be collected and distributed for only for those months that have been chosen by existing circle participants with stated yields remaining intact.

Existing online P2P lenders create securities (as defined by the SEC) that are bought/sold every time a loan is underwritten. As opposed to this practice, we propose, as part and parcel of our online lending business model, to enable lending through the creation of individual loan contracts between all participants in a group/circle. For example, if there are 12 participants in a particular circle, we propose to have the business arrangement based on twelve individual lending contracts. Each contract is defined by terms that specify individuals in the circle will borrow money from 12 lenders (one at a time) and agree to a payment plan that sets forth monthly payments comprised of principal plus interest over a 12 month period. If there are 10 participants in the circle, there will be ten individual contracts. If there are 8 participants in a circle, 8 contracts will be signed, etc.

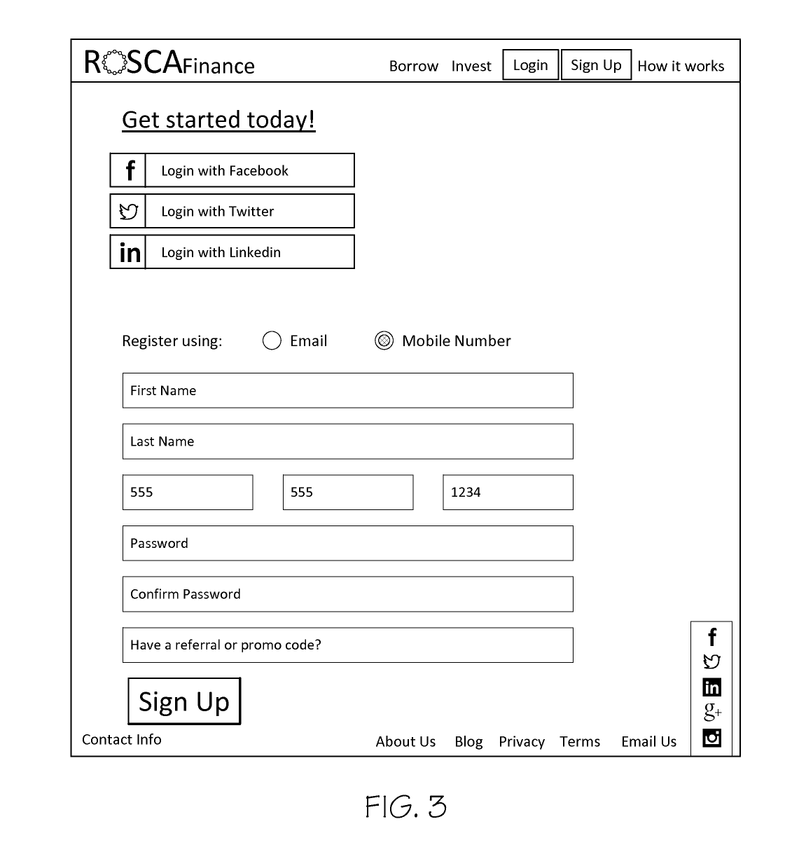

Referring now to FIG. 3, the present invention offers a perspective participant a graphic user interface to sign up for a new ROSCA user account. In one exemplary embodiment, the interface is browser-based offered as part of a website. There, the individual may sign up as a new ROSCA user using his Facebook, LinkedIn, Twitter, email or a mobile number.

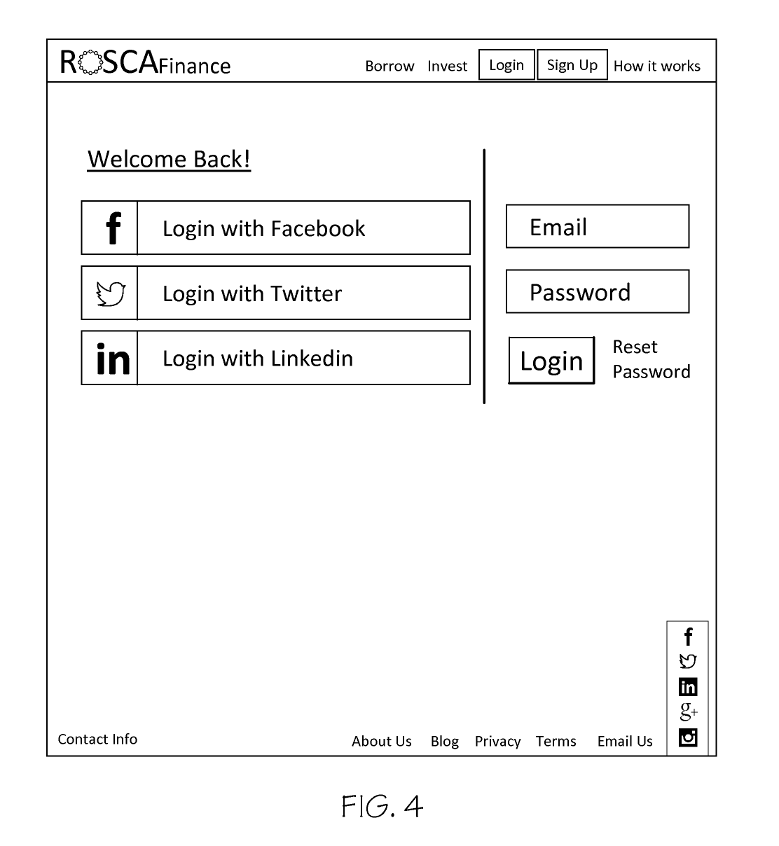

FIG. 4 depicts an exemplary embodiment of the interface used by an already registered user log onto his or her existing ROSCA user account.

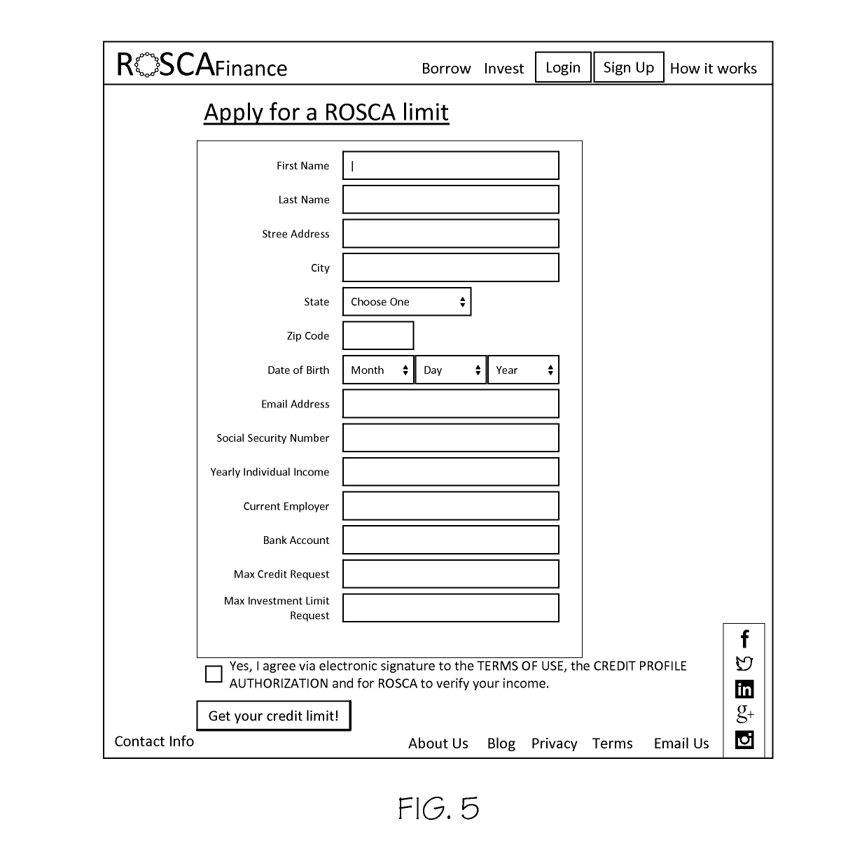

Using an exemplary embodiment of the interface shown in FIG. 5, an existing user may apply online for a ROSCA borrowing limit. The participant uses the interface to apply online for a ROSCA limit for borrowing and investing by submitting personal information and acknowledging the Terms of Use and Credit Authorization.

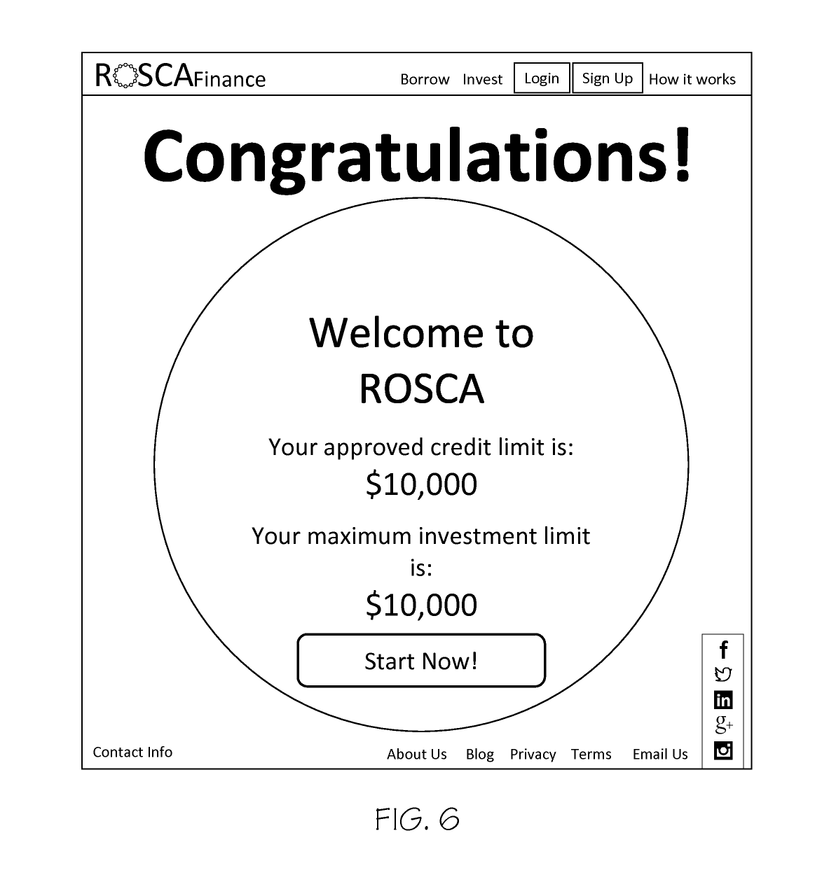

FIG. 6 exemplifies the interface through which a qualified applicant receives approvals of the credit and investment limits respectively. Upon completion of an underwriting process handled by the application layer, the qualified applicant will receive a real-time approval of credit and investment limits.

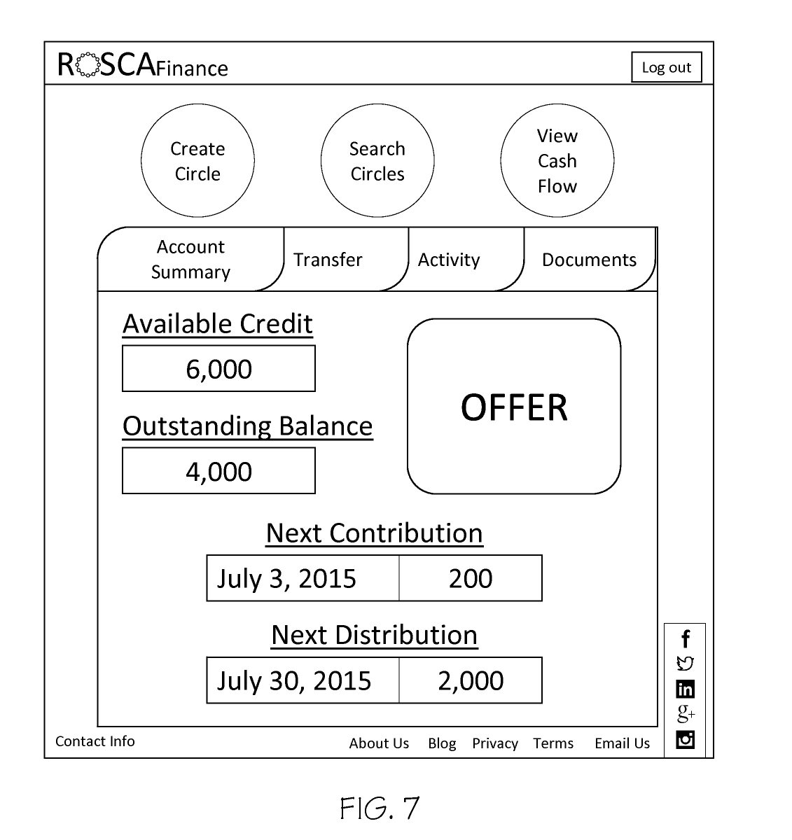

FIG. 7 shows an exemplary embodiment of the activity page. In some embodiments, and upon credit approval and credit limit issuance, the participant is be directed to the shown activity page that allows the participant to choose from a selection of: (1) viewing his or her account summaries; (2) creating new circles; (3) joining existing circles; (4) analyzing their cash flow; (5) transferring funds; (6) viewing account activity; and (7) downloading pertinent documentation.

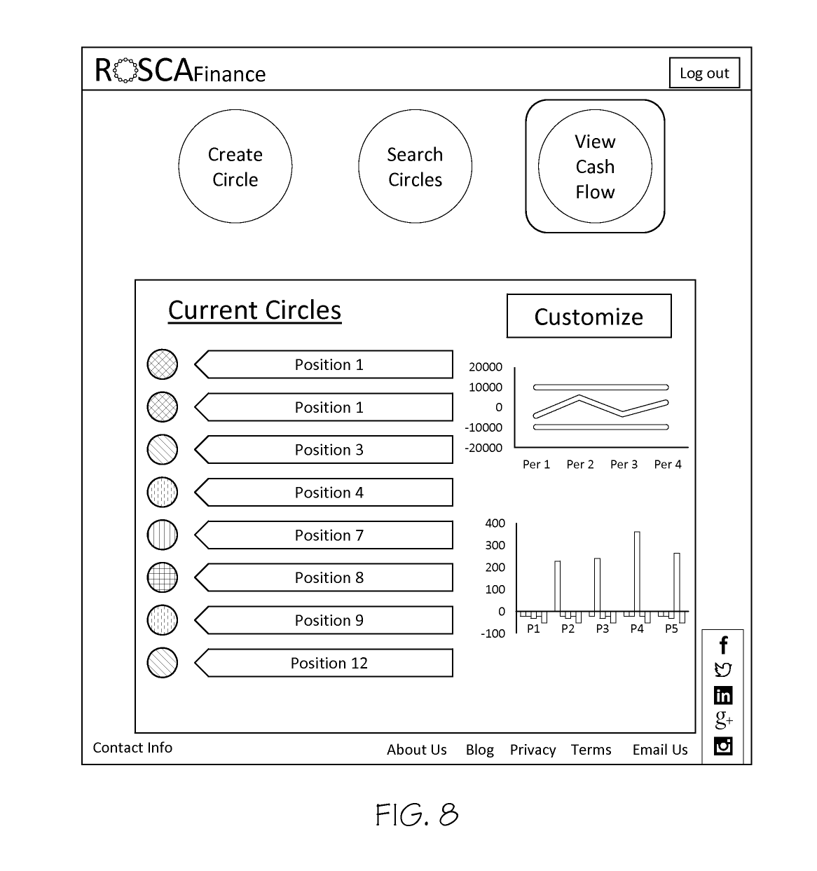

FIG. 8 depicts an exemplary embodiment of the interface that provides for real-time viewing of actual and potential cash flows generated by a given circle participation. Among the actions users can take while utilizing this exemplary interface, it is of a particular significance that the online interface with users allows ROSCA Finance to provide “real-time” graphical viewing of actual and potential cash flows that are generated by committed and theorized circle participation. In addition, users are able to analyze their data and customize reports according to individual preferences.

The foregoing workflow, exercised through a computer network-based system, offers a reliable mechanism for ensuring that peer-to-peer lending is sufficiently traced and all pertinent documentation is properly preserved.

Method embodiments described herein are computer-implemented. Some embodiments include computer-readable media encoded with a computer program (e.g. software), which includes instruction operable to cause an electronic device such as a computer or computer network to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but not limited to, hard disks, removable magnetic disks, removable optical disks (e.g. computer disks and digital video disks), memory cards or sticks, random access memories (RAM), read only memories (ROM), and the like.

The description of the present embodiment has been presented for purposes of illustration, but is not intended to be exhaustive or to limit the invention to the form disclosed. Many modifications and variations will be apparent to those of ordinary skill in the art. For example, the processes of the present invention are capable of being distributed in the form of a computer readable medium of instructions. Such computer readable medium may have a variety of forms. The present invention applies equally regardless of the particular type of signal bearing media actually used to carry out the distribution. Examples of tangible computer readable media include recordable-type media such a flush drive, a hard disk drive, a RAM, and CD-ROMs. Examples of transmission-type media include digital and analog communications links.

Various embodiments implement the one or more software programs in various ways, including procedure-based techniques, component-based techniques, and/or object-oriented techniques, among others. Specific examples include C#, .NET and commercial class libraries. Those of ordinary skill in the art will appreciate that the hardware depicted herein may vary depending on the implementation. The depicted example is not meant to imply architectural limitations with respect to the present invention.

The terms “logic,” “model” and “memory” may have been used herein. While the logic and model referred to herein have generally be described in terms of instructions, data structures and computer processes, it should be understood that these terms may alternatively refer to circuitry that is part of the design for an integrated circuit chip.

Herein above, or in the following claims, the term “comprises” is synonymous with “includes.” The use of terminology such as “X comprises A, B and C” is not intended to imply that A, B and C are necessarily the only components or most important components of X.

Unless clearly and explicitly stated, the claims that follow are not intended to imply any particular sequence of actions. The inclusion of labels, such as a), b), c) or 1), 2), 3) etc., for portions of the claims does not, by itself, imply any particular sequence, but rather is merely to facilitate reference to the portions.

To reiterate, the embodiments were chosen and described in order to best explain the principles of the invention, the practical application, and to enable others of ordinary skill in the art to understand the invention. Various other embodiments having various modifications may be suited to a particular use contemplated, but may be within the scope of the present invention.

We claim:

1. An improved online computer-based peer-to-peer lending and saving method comprising:
receiving, by a process running on a computer system, credit-related information from a plurality of participants;
correlating and transmitting electronically said credit-related information into a credit-scoring module;
determining and assigning credit ratings and credit rating-based maximum credit limits for each of said plurality of participants;
defining peer-to-peer lending circles based on said credit ratings and said credit rating-based maximum credit limits;
for each of said lending circles, determining an interest rate, an amount of monthly contributions from each of said plurality of participants joining said circle, and monthly payment increases to compensate for time value of money and risk of default;
allowing said participants to select one or more said lending circles whereas said participants cannot be assigned to lending circles with a credit rating higher than that of said participants, and having no less than two, and nor more than 12 of said participant per each of said lending circles;
allowing said participants to select one and only one funds distribution month per lending circle within a 12-months period, such that no two participants of the same lending circle select the same distribution months;
collecting from each participant in the defined lending circle the sum of money they are obligated to contribute in the current month or period;
distributing monthly contributions from of each of said participants of each lending circle, less costs, to a participant who selected the current month as the participant's funds distribution month;
terminating each of said lending circles after last participant of each circle receives said last participant's funds distribution.

2. The improved online peer-to-peer lending method of claim 1 further comprising:
for each of said plurality of participants, calculating future projected credit limit usage based on future contributions for each lending circle said participant joined;
increasing said future projected credit limit for said participant in the amount equal to sum of monthly contributions made prior to funds distribution month of said participant;
reducing said future projected credit limit for said participant in the amount equal to sum of funds distributed to said participant.

3. An online peer-to-peer lending computer system comprising:
a processor; and
a storage device connected to said processor, wherein said storage device has stored thereon an online peer-to-peer lending software program for controlling said processor, and wherein said processor is operative with said program to execute said program for receiving credit-related information from a plurality of participants;
wherein said processor is operative with said program to execute said program for transmitting electronically said credit-related information into a credit analyzing module;
wherein said processor is operative with said program to execute said program for determining and assigning credit ratings and credit rating-based maximum credit limits for each of said plurality of participants;
wherein said processor is operative with said program to execute said program for defining peer-to-peer lending circles based on said credit ratings and said credit rating-based maximum credit limits;
wherein said processor is operative with said program to execute said program for determining an interest rate, an amount of monthly contributions from each of said plurality of participants joining said circle, and monthly payment increases to compensate for time value of money and risk of default;
wherein said processor is operative with said program to execute said program for allowing said participants to select one or more said lending circles whereas said participants cannot be assigned to lending circles with a credit rating higher than that of said participants, and having no less than two, and nor more than 12 of said participant per each of said lending circles;
wherein said processor is operative with said program to execute said program for allowing said participants to select one and only one funds distribution month per lending circle within a 12-months period, such that no two participants of the same lending circle select the same distribution months;
wherein said processor is operative with said program to execute said program for collecting the monthly contribution from each of said participants of each lending circle;
wherein said processor is operative with said program to execute said program for distributing monthly contributions from of each of said participants of each lending circle, less costs, to a participant who selected the current month as the participant's funds distribution month;
wherein said processor is operative with said program to execute said program for terminating each of said lending circles after last participant of each circle receives said last participant's funds distribution.

4. The online peer-to-peer lending computer system of claim 3 further comprising:
wherein said processor is operative with said program to execute said program for calculating future projected credit limit for each of said plurality of participants usage based on future contributions for each lending circle said participant joined;
wherein said processor is operative with said program to execute said program for increasing said future projected credit limit for said participant in the amount equal to sum of monthly contributions made prior to funds distribution month of said participant;
wherein said processor is operative with said program to execute said program for reducing said future projected credit limit for said participant in the amount equal to sum of funds distributed to said participant.

5. A computer-implemented algorithm for an improved online peer-to-peer lending platform, said computer-implemented algorithm comprising:
a computer readable storage medium having computer readable program code embodied therewith, said computer readable program code further comprising:
computer readable program code configured to cause a computer system to receive, by a process running on a computer system, credit-related information from a plurality of participants;
computer readable program code configured to cause a computer system to correlate and transmit electronically said credit-related information into a credit-analyzing module;
computer readable program code configured to cause a computer system to determine and assign credit ratings and credit rating-based maximum credit limits for each of said plurality of participants;
computer readable program code configured to cause a computer system to define peer-to-peer lending circles based on said credit ratings and said credit rating-based maximum credit limits;
computer readable program code configured to cause a computer system, for each of said lending circles, to determine an interest rate, an amount of monthly contributions from each of said plurality of participants joining said circle, and monthly payment increases to compensate for time value of money and risk of default;
computer readable program code configured to cause a computer system to allow said participants to select one or more said lending circles whereas said participants cannot be assigned to lending circles with a credit rating higher than that of said participants, and having no less than two, and nor more than 12 of said participant per each of said lending circles;
computer readable program code configured to cause a computer system to allow said participants to select one and only one funds distribution month per lending circle within a 12-months period, such that no two participants of the same lending circle select the same distribution months;
computer readable program code configured to cause a computer system to collect the monthly contributions from each participant of the lending circle;
computer readable program code configured to cause a computer system to distribute monthly contributions from of each of said participants of each lending circle less costs to a participant who selected the current month as the participant's funds distribution month;
computer readable program code configured to cause a computer system to terminate each of said lending circles after last participant of each circle receives said last participant's funds distribution.

6. The computer-implemented algorithm for said improved online peer-to-peer lending platform to claim 5 further comprising:
computer readable program code configured to cause a computer system, for each of said plurality of participants, to calculate future projected credit limit usage based on future contributions for each lending circle said participant joined;
computer readable program code configured to cause a computer system to increase said future projected credit limit for said participant in the amount equal to sum of monthly contributions made prior to funds distribution month of said participant;
computer readable program code configured to cause a computer system to reduce said future projected credit limit for said participant in the amount equal to sum of funds distributed to said participant.
